(19) United States
(12) Patent Application Publication
(10) Pub. No.: US 2015/0358519 A1
(43) Pub. Date: Dec. 10, 2015

(54) CAMERA HEAD, CONNECTING METHOD OF CAMERA HEAD AND ENDOSCOPE APPARATUS

(71) Applicant: Kabushiki Kaisha Toshiba, Tokyo (JP)

(72) Inventor: Takatoshi Kamei, Oume (JP)

(21) Appl. No.: 14/593,986

(22) Filed: Jan. 9, 2015

(30) Foreign Application Priority Data
Jun. 6, 2014 (JP) 2014-117646

(51) Int. Cl. H04N 5/225; H04N 7/10; G02B 7/18; G02B 13/00; G02B 7/02

(52) U.S. Cl. CPC H04N 5/2254; H04N 5/2256; H04N 5/2257; G02B 13/0065; G02B 7/02; G02B 7/1805; H04N 7/10

(57) ABSTRACT

A camera head of an embodiment includes: a lens unit; a prism having an inclined surface which changes a traveling direction of light which passed the lens unit and an emission surface from which the light changed in traveling direction is emitted; an imaging element which outputs an electrical signal; a signal cable; a support member having a first surface having an inclination corresponding to the inclined surface and attached to a rear-side surface of the inclined surface, an insertion hole in which the signal cable is inserted, and a second surface having a connecting part electrically connected to the signal cable inserted in the insertion hole; and a wiring substrate having a first area where the imaging element is mounted and a second area electrically connected to the connecting part.

### CROSS-REFERENCE TO RELATED APPLICATION

This application is based upon and claims the benefit of priority from Japanese Patent Application No. 2014-117646, filed on Jun. 6, 2014; the entire contents of which are incorporated herein by reference.

### FIELD

Embodiments described herein generally relate to a camera head, a connecting method of a camera head and an endoscope apparatus.

### BACKGROUND

Conventional imaging apparatuses (endoscope apparatuses for example) include an imaging apparatus of head-separated type, in which a head unit having an imaging element (for example, a CMOS (Complementary Metal Oxide Semiconductor) image sensor or a CCD (Charge Coupled Device) image sensor) and a main body part which processes an image signal transmitted from this head unit are separated. In recent years, size reduction of this head-separated imaging apparatus is in progress, and there have been proposed various imaging apparatuses so as to allow size reduction of the head.

### BRIEF DESCRIPTION OF THE DRAWINGS

FIG. 1 is a structural diagram of an imaging apparatus according to a first embodiment.

FIG. 2 is a view illustrating part of a head unit according to the first embodiment by a cross section.

FIG. 3 is an exploded perspective view of a camera head unit and a cable according to the first embodiment.

FIG. 4 is an enlarged view of a base according to the first embodiment.

FIG. 5 is a view illustrating a cross section of the base according to the first embodiment.

FIG. 6 is an exploded perspective view of a camera head unit and a cable according to a second embodiment.

FIG. 7 is a view illustrating part of a camera head unit according to a third embodiment by a cross section.

### DETAILED DESCRIPTION

In a head-separated imaging apparatus, further size reduction of a head unit is demanded. However, it may become difficult to ensure rigidity of the head unit when it is reduced in size.

Embodiments are made for solving such conventional problems, and it is an object thereof to provide a camera head, a connecting method of a camera head and an endoscope apparatus which allow reducing the size and ensuring the rigidity of the head unit.

A camera head of an embodiment includes: a lens unit; a prism having an inclined surface which changes a traveling direction of light which passed the lens unit and an emission surface from which the light changed in traveling direction is emitted; an imaging element which outputs an electrical signal; a signal cable; a support member having a first surface having an inclination corresponding to the inclined surface and attached to a rear-side surface of the inclined surface, an insertion hole in which the signal cable is inserted, and a second surface having a connecting part electrically connected to the signal cable inserted in the insertion hole; and a wiring substrate having a first area where the imaging element is mounted and a second area electrically connected to the connecting part.

### First Embodiment

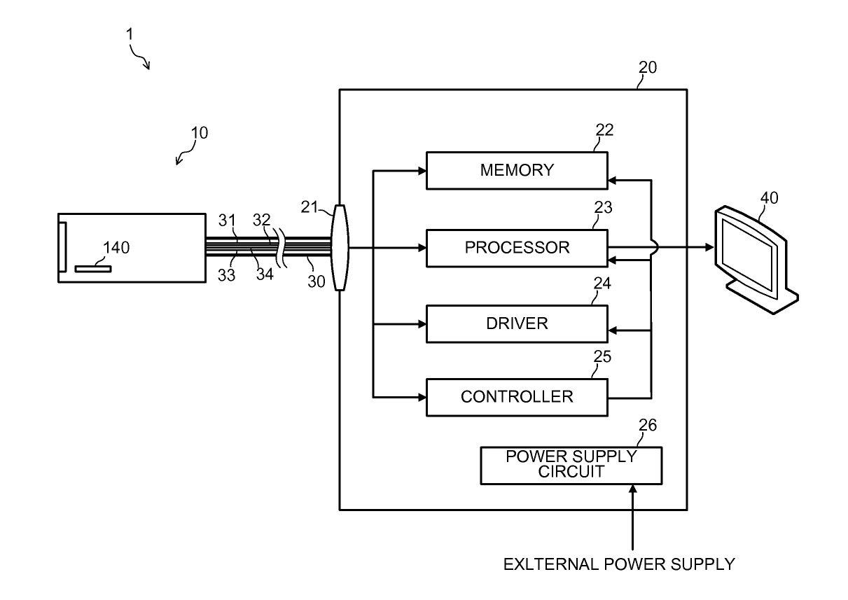

Hereinafter, with reference to the drawings, embodiments will be described in detail. FIG. 1 is a structural diagram of an imaging apparatus 1 according to a first embodiment. In this first embodiment, a structure of an endoscope apparatus as an example of the imaging apparatus will be described. The imaging apparatus 1 may either be a rigid endoscope apparatus (type in which a scope to be inserted in an inspected object is rigid and does not bend) or a flexible endoscope apparatus (type in which a scope to be inserted in an inspected object is flexible and bends). In this first embodiment, the imaging apparatus 1 is the flexible endoscope apparatus. The imaging apparatus 1 has a head unit 10, a main body part 20, and a cable 30 connecting the head unit 10 and the main body part 20.

The head unit 10 has an image sensor 140. The image sensor 140 is an imaging element. The image sensor 140 is, for example, a CMOS (Complementary Metal Oxide Semiconductor) image sensor. As the image sensor 140, a CCD (Charge Coupled Device) image sensor may also be used. The head unit 10 outputs an image signal outputted by the image sensor 140 to the main body part 20.

The main body part 20 has an IF circuit 21, a memory 22, a processor 23, a driver 24, a controller 25, and a power supply circuit 26. The main body part 20 may also be referred to as a CCU (Camera Control Unit).

The IF circuit 21 is an interface for performing transmission/reception of a control signal, an image signal, and the like to/from the head unit 10. The memory 22 is a non-volatile memory. The memory 22 stores setting data (operating modes) of the head unit 10 and correction data.

The processor 23 processes an image signal transmitted from the head unit 10. The processor 23 performs various corrections (for example, noise correction, white balance, γ correction, and the like) on the image signal transmitted from the head unit 10. The processor 23 outputs an image signal after corrected to an external display device 40 (for example, CRT (Cathode Ray Tube) or liquid-crystal monitor).

The driver 24 is a driving circuit of the image sensor 140. The driver 24 is controlled by the controller 25 to change a driving method, a frame rate and the like of the image sensor 140. Further, the driver 24 outputs a pulse signal to the image sensor 140. This pulse signal is, for example, a signal for vertical synchronization or horizontal synchronization.

The controller 25 reads the correction data and the setting data from the memory 22. The controller 25 controls the processor 23 and the driver 24 based on the read correction data and setting data.

The power supply circuit 26 is connected to an external power supply. The power supply circuit 26 converts power of the external power supply to a predetermined voltage, and supplies the power to the IF circuit 21, the memory 22, the processor 23, the driver 24, and the controller 25. Further, the power of the power supply circuit 26 is also supplied to the head unit 10 via the cable 30.

The cable 30 accommodates plural cables (signal cables) 31 to 34. The cable 31 transmits, for example, a data signal (image signal). The cable 32 transmits, for example, a synchronization signal (pulse signal for vertical synchronization and horizontal synchronization). The cable 33 functions as, for example, a supply line of power. The cable 34 functions as, for example, a GND line. Among the cables 31 to 34, it is desired to use a coaxial cable for the cable 31 and the cable 32.

### (Regarding Configurations of the Head Unit 10 and the Cable 30)

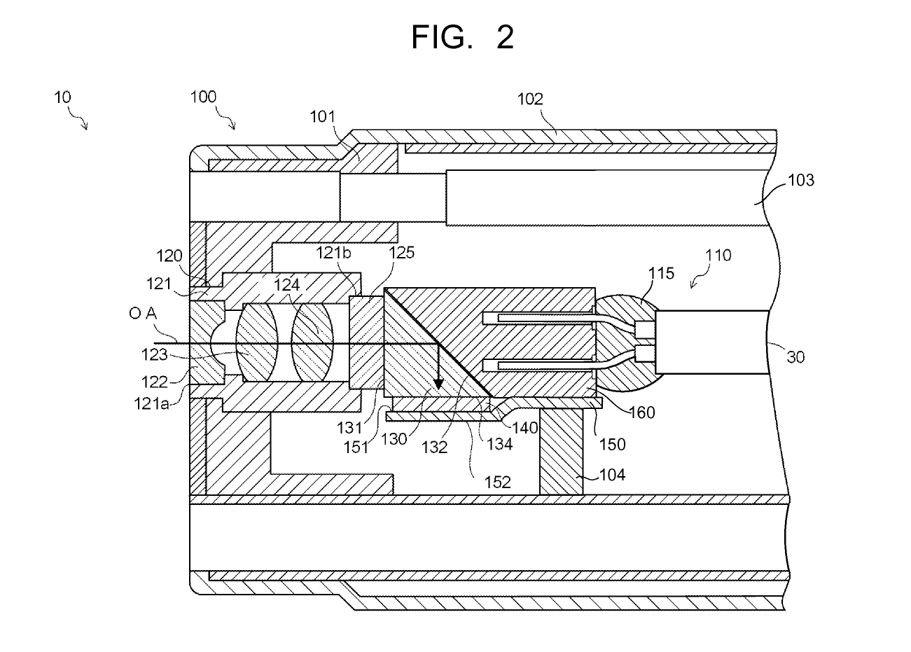

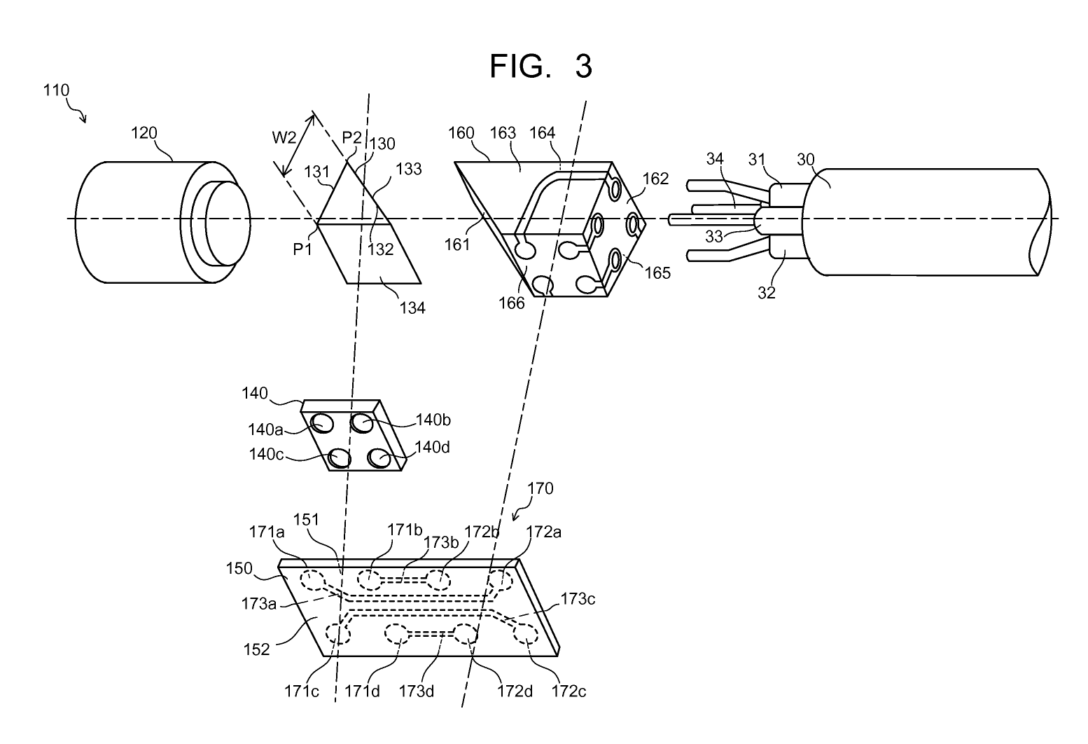

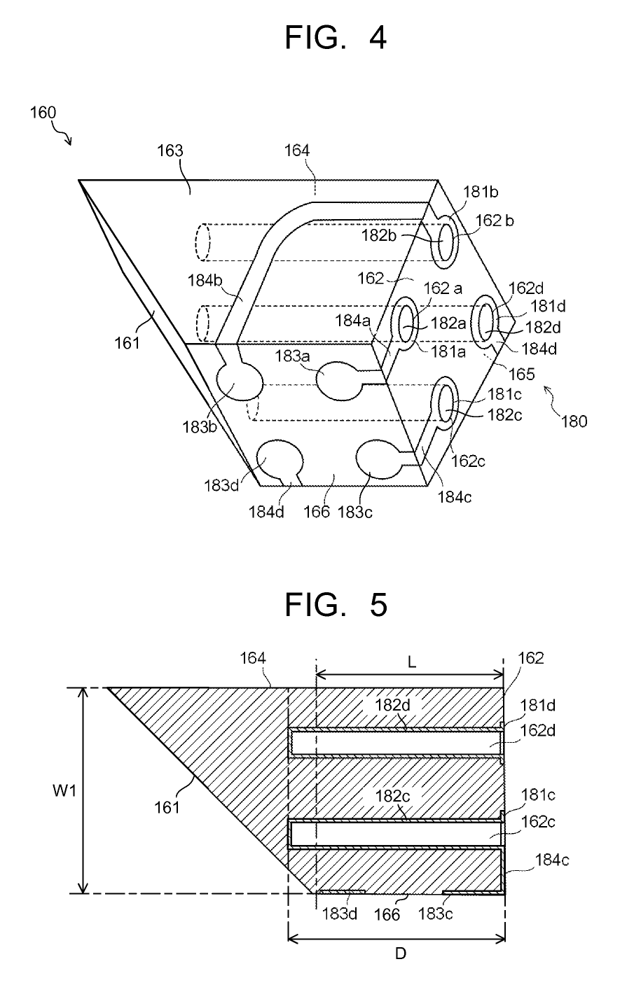

Next, configurations of the head unit 10 and the cable 30 will be described in detail using FIG. 2 to FIG. 5. FIG. 2 is a view illustrating part of the head unit 10 by a cross section. In FIG. 2, for clarity of the view, a cross section of part of members such as the cable 30 is not illustrated. FIG. 3 is an exploded perspective view of a camera head unit 110 and the cable 30. FIG. 4 is an enlarged view of a base 160. FIG. 5 is a cross-sectional view of the base 160.

As illustrated in FIG. 2, the head unit 10 is constituted of a peripheral unit 100 and a camera head unit 110 (camera head). The peripheral unit 100 has a front end case 101, a protection rubber 102, an optical fiber 103, and a holding member 104. The front end case 101 is formed from metal or plastic for example. By the front end case 101, a predetermined rigidity can be given to the front end of the head unit 10. The protection rubber 102 is a protection member for preventing damage to a human body when the head unit 10 is inserted into the body. The optical fiber 103 is connected to a light source control device of the main body part 20 which is not illustrated here. The optical fiber 103 is for guiding light for illuminating the inside of the human body.

The holding member 104 is formed from metal or plastic for example. The holding member 104 holds the camera head unit 110. The holding member 104 and the camera head unit 110 can be bonded with adhesive. The camera head unit 110 has a lens unit 120, a right-angle prism 130, the image sensor 140, an FPC (Flexible printed circuit) 150, and the base 160.

The lens unit 120 is constituted of a lens case 121 and plural optical lenses 122 to 125 disposed in this lens case 121. The lens case 121 is formed in a substantially cylindrical shape. The lens case 121 has a light incident hole 121a and a light emission hole 121b. The optical lens 122 is disposed in the light incident hole 121a. The optical lens 125 is disposed in the light emission hole 121b. The optical lenses 123 and 124 are disposed between the optical lenses 122 and 125.

In the lens unit 120 having the above configuration, light passes through the optical lens 122 and enters the inside of the lens unit 120. An optical axis OA is substantially parallel to a longitudinal direction of the lens unit 120. The light which entered the inside of the lens unit 120 passes through the optical lenses 123 to 125 and is incident on the right-angle prism 130.

The right-angle prism 130 has an incident surface 131, a reflection surface 132, a rear surface 133, and an emission surface 134. The right-angle prism 130 bends the optical axis with the reflection surface 132 (light refraction part) to make it substantially at right angles and guides the light which passed through the lens unit 120 to the image sensor 140. On the incident surface 131, the light is incident from the optical lens 125. From the emission surface 134, the light whose traveling direction is bent substantially at right angles by the reflection surface 132 is emitted. The rear surface 133 is a rear-side surface of the reflection surface 132.

The image sensor 140 is one substantially rectangular silicon chip. The image sensor 140 is disposed under the right-angle prism 130. Part of the image sensor 140 which is in contact with the right-angle prism 130 is a light receiving part. The image sensor 140 receives the light emitted from the right-angle prism 130.

The image sensor 140 outputs an electrical signal (image signal) corresponding to the received light to the FPC 150. Although a detailed illustration is omitted here, the image sensor 140 incorporates a circuit unit such as an A/D converting circuit. The image sensor 140 is fixed to the right-angle prism 130 by, for example, an optical adhesive such as a UV curing adhesive.

As illustrated in FIG. 3, on a lower surface part of the image sensor 140, electrodes 140a to 140d to be connected to the FPC 150 are formed. The FPC 150 is a wiring substrate having flexibility. The FPC 150 has a rectangular shape. On a front surface 151, an electrical wiring 170 is disposed. The electrical wiring 170 has land parts 171a to 171d, land parts 172a to 172d, and connecting wire parts 173a to 173d. The land part 171a is electrically connected to the electrode 140a which the image sensor 140 has.

Similarly, the land parts 171b to 171d are electrically connected to the electrodes 140b to 140d, respectively, which the image sensor 140 has. That is, an end portion of the FPC 150 where the land parts 171a to 171d are located functions as a mounting area (first area) where the image sensor 140 is mounted. The land parts 171a to 171d and the electrodes 140a to 140d can be connected with solder. Note that the correspondence between the land parts 171a to 171d and the electrodes 140b to 140d are not limited in particular, and various variations exist. For example, the land part 171a and the electrode 140d may be connected.

The land parts 172a to 172d (third connecting part) are electrically connected to the base 160. An end portion of the FPC 150 where the land parts 172a to 172d are located is a second area electrically connected to the above-described mounting area (first area). The land parts 172a to 172d and the base 160 can be connected with solder. The connecting wire part 173a connects the land part 171a and the land part 172a. Similarly, the connecting wire parts 173b to 173d connect the land parts 171b to 171d and the land parts 172b to 172d, respectively.

The base 160 functions as a support member. As illustrated in FIG. 4 and FIG. 5, the base 160 is formed in a substantially square prism form with one end side being cut off obliquely. The base 160 is an MID (Molded Interconnect Device). That is, the base 160 is a circuit forming part made by injection molding a resin such as a plastic and forming an electrical wiring pattern on an outer peripheral surface, and the like.

The base 160 has an inclined surface 161, a bottom surface 162, first to fourth side surfaces 163 to 166, and an electrical wiring 180. A width W1 of the base 160 (length from the fourth side surface 166 to the second side surface 164) corresponds to a width W2 of the incident surface 131 of the right-angle prism 130 illustrated in FIG. 3 (length from a connecting part P1 of the incident surface 131 and the emission surface 134 to a connecting point P2 of the incident surface 131 and the rear surface 133).

The inclined surface 161 (first surface) has an inclination corresponding to the rear surface 133 which the right-angle prism 130 has. The area of the inclined surface 161 corresponds to the area of the rear surface 133. The inclined surface 161 is bonded to the rear surface 133 with adhesive made of resin for example. The bottom surface 162 (second surface) is located on the side opposite to the inclined surface 161 across the first to fourth side surfaces 163 to 166. In the bottom surface 162, insertion holes 162a to 162d are formed.

The insertion holes 162a to 162d are formed in a cylindrical shape from the bottom surface 162 toward the inclined surface 161. The insertion holes 162a to 162d are disposed along four sides of the bottom surface 162. Centers of the insertion holes 162a to 162d are located respectively at vertexes of a virtual square. Conducting wire parts of the cables 31 to 34 where the insulation is removed are inserted in the insertion holes 162a to 162d. Here, the conducting wire part of the cable 33 is inserted in the insertion hole 162a. Similarly, the conducting wire part of the cable 31 is inserted in the insertion hole 162b. The conducting wire part of the cable 32 is inserted in the insertion hole 162c. The conducting wire part of the cable 34 is inserted in the insertion hole 162d.

The insertion holes 162a to 162d and the cables 31 to 34 are electrically connected with solder (not illustrated). Then, the cables 31 to 34 are firmly fixed to the base 160 with adhesive 115 (see FIG. 2). A depth D (length in a direction from the bottom surface 162 to the inclined surface 161) of the insertion holes 162a to 162d are longer than a length L of the side surface 166 (see FIG. 5).

The side surface 166 (third surface) is in contact with the FPC 150. The electrical wiring 180 has land parts 181a to 181d, in-hole wires 182a to 182d, land parts 183a to 183d, and connecting wire parts 184a to 184d. The land parts 181a to 181d function as a connecting part electrically connecting the cables 31 to 34 inserted in the insertion holes 162a to 162d and the FPC 150.

The land part 181a is disposed in an edge portion of the insertion hole 162a so as to surround the insertion hole 162a. Similarly, the land parts 181b to 181d are disposed in edge portions of the insertion holes 162b to 162d, respectively, so as to surround the insertion holes 162b to 162d.

The in-hole wire 182a is a conductive layer covering a wall surface of the insertion hole 162a. The in-hole wire 182a is connected to the land part 181a. Similarly, the in-hole wires 182b to 182d are conductive layers covering wall surfaces of the insertion holes 162b to 162d, respectively. The in-hole wires 182b to 182d are connected respectively to the land parts 181b to 181d.

The land parts 183a to 183d function as a second connecting part electrically connected to the FPC 150. The land part 183a is electrically connected to the land part 172a which the FPC 150 has. Similarly, the land parts 183b to 183d are electrically connected to the land parts 172b to 172d, respectively, which the FPC 150 has. The land parts 183a to 183d and the land parts 172a to 172d can be connected with solder. The correspondence of connection of the land parts 183a to 183d and the land parts 172a to 172d are not particularly limited, and various versions exist. For example, the land part 183a and the land part 172d can be connected.

The connecting wire part 184a connects the land part 181a and the land part 183a. The connecting wire part 184a is disposed on the bottom surface 162 and the side surface 166. Similarly, the connecting wire parts 184b to 184d connect the land parts 181b to 181d and the land parts 183b to 183d, respectively.

The connecting wire part 184b is disposed from the bottom surface 162 to the side surface 166 via the side surface 163. Similarly to the connecting wire part 184a, the connecting wire part 184c is disposed on the bottom surface 162 and the side surface 166. The connecting wire part 184d is disposed from the bottom surface 162 to the side surface 166 via the side surface 165. The connecting wire part 184b and the connecting wire part 184d have mutually corresponding shapes. The connecting wire part 184a and the connecting wire part 184c have mutually corresponding shapes. The above is the structure of the base 160.

### (Regarding Connection of the Lens Unit 120 to the Cables 31 to 34)

Next, with reference to FIG. 2 and FIG. 3, connection of the lens unit 120 to the cables 31 to 34 will be described. Note that in FIG. 2, adhesive and solder are not illustrated in particular.

(1) Attaching the Image Sensor 140

As illustrated in FIG. 3, first, the right-angle prism 130 is prepared. Then, the FPC 150 on which the image sensor 140 is mounted is prepared. The emission surface 134 of the right-angle prism 130 and the image sensor 140 are bonded with adhesive.

(2) Attaching the Lens Unit 120

The incident surface 131 of the right-angle prism 130 and the optical lens 125 of the lens unit 120 are bonded with adhesive.

(3) Attaching the Base 160

The base 160 is prepared. Then, the inclined surface 161 of the base 160 and the rear surface 133 of the right-angle prism 130 are bonded with adhesive. Next, the base 160 and the FPC 150 are soldered.

(4) Attaching the Cables 31 to 34

The cables 31 to 34 are exposed from the cable 30. Insulations of the exposed cables 31 to 34 are removed to expose the conducting wire parts. The cables 31 to 34 are inserted in the insertion holes 162a to 162d of the base 160, respectively, and soldered.

(5) Sealing

The adhesive 115 is applied in the vicinities of the insertion holes 162a to 162d of the base 160, to thereby fix the cables 31 to 34 and the base 160.

In this imaging apparatus 1 according to the first embodiment, by having the base 160, the following effects (1) to (3) can be obtained. As a result, in the imaging apparatus 1, it is possible to reduce the size and ensure the rigidity of the camera head unit 110. By reducing the size of the camera head unit 110, the peripheral unit 100 can be reduced in size. As a result, the entire head unit 10 can be reduced in size in the depth D direction and the width W1 direction illustrated in FIG. 5.

(1) In the imaging apparatus 1, the right-angle prism 130 and the base 160 are bonded, and the cables 31 to 34 are connected to the base 160. By this, the right-angle prism 130 and the cables 31 to 34 are fixed to the base 160 as the MID. Therefore, it is not necessary to separately provide a holding case for holding the lens unit 120, the right-angle prism 130, and the cables 31 to 34. Then, by the base 160, the rigidity of the entire camera head unit 110 can be ensured without separately providing the holding case.

(2) In the imaging apparatus 1, by the inclined surface 161, the base 160 can be bonded to the rear surface 133 of the right-angle prism 130, and thus formation of an unnecessary space in the vicinity of the rear surface 133 can be prevented.

(3) In the base, the insertion holes 162a to 162d are formed in the bottom surface 162 located on the side opposite to the inclined surface 161 across the first to fourth side surfaces 163 to 166. Since the cables 31 to 34 are inserted in these insertion holes 162a to 162d, the lens unit 120, the right-angle prism 130, the base 160, and the cables 31 to 34 can be disposed in a straight line.

Moreover, in the imaging apparatus 1, by having the base 160, the following effects (4) to (9) can be obtained.

(4) The base 160 has the inclined surface 161 having an inclination corresponding to the rear surface 133 which the right-angle prism 130 has. Since the inclined surface 161 and the rear surface 133 of the right-angle prism 130 are bonded, it is easy to ensure bonding strength.

(5) In the base 160, the width W1 illustrated in FIG. 5 corresponds to the width W2 of the incident surface 131 of the right-angle prism 130 illustrated in FIG. 3. Therefore, when the base 160 and the right-angle prism 130 are bonded, the fourth side surface 166 of the base 160 and the emission surface 134 of the right-angle prism 130 can be made flat. As a result, the camera head unit 110 can be reduced in size in the width W1 direction.

(6) Since the cables 31 to 34 are inserted in the insertion holes 162a to 162d and soldered therewith, the connecting work of the cables 31 to 34 to the base 160 can be performed efficiently. Describing specifically, by having the insertion holes 162a to 162d, the positions of the cables 31 to 34 with respect to the insertion holes 162a to 162d can be determined easily. By capillary phenomenon, the solder instantly spread through the insertion holes 162a to 162d, and thus the cables 31 to 34 can be soldered quickly and securely to the insertion holes 162a to 162d.

(7) In the base 160, the depth D of the insertion holes 162a to 162d is longer than the length L of the side surface 166. By making the depth D longer than the length L, a sufficient length can be ensured for inserting the conducting wire parts of the cables 31 to 34 without changing external dimensions of the base 160.

For example, there may be cases where the insertion holes 162a to 162d do not have a sufficient length for inserting the conducting wire parts of the cables 31 to 34. In this case, the conducting wire parts of the cables 31 to 34 may jam in the insertion holes 162a to 162d in the connecting step of the base 160 and the cables 31 to 34.

In this case, the cables 31 to 34 are pushed back, and it becomes difficult to determine the positions of the cables 31 to 34 relative to the insertion holes 162a to 162d. As a result, a dispersion of connection of the cables 31 to 34 and the base 160 may occur in each product. For example, the conducting wire parts of the cables 31 to 34 may be largely exposed from the insertion holes 162a to 162d. By forming the insertion holes 162a to 162d longer than the length L, the dispersion in each product can be prevented.

(8) In the imaging apparatus 1, the image sensor 140 is disposed under the right-angle prism 130. By this, the disposition space for the image sensor 140 can be ensured sufficiently. As a result, the image sensor 140 can be increased in size.

By increasing the size of the image sensor 140, image data with high resolutions can be obtained, and it can be stronger against noise. In short, in the imaging apparatus 1, while the camera head unit 110 is reduced in size by the base 160, the image sensor 140 can be increased in size.

(9) The imaging apparatus 1 has the right-angle prism 130. By this, while the right-angle prism 130 is fixed with a jig, the lens unit 120 can be easily attached to this right-angle prism 130. By fixing the right-angle prism 130 with a jig, it becomes easy to adjust the optical axis. As a result, the imaging apparatus 1 can be produced efficiently.

### Second Embodiment

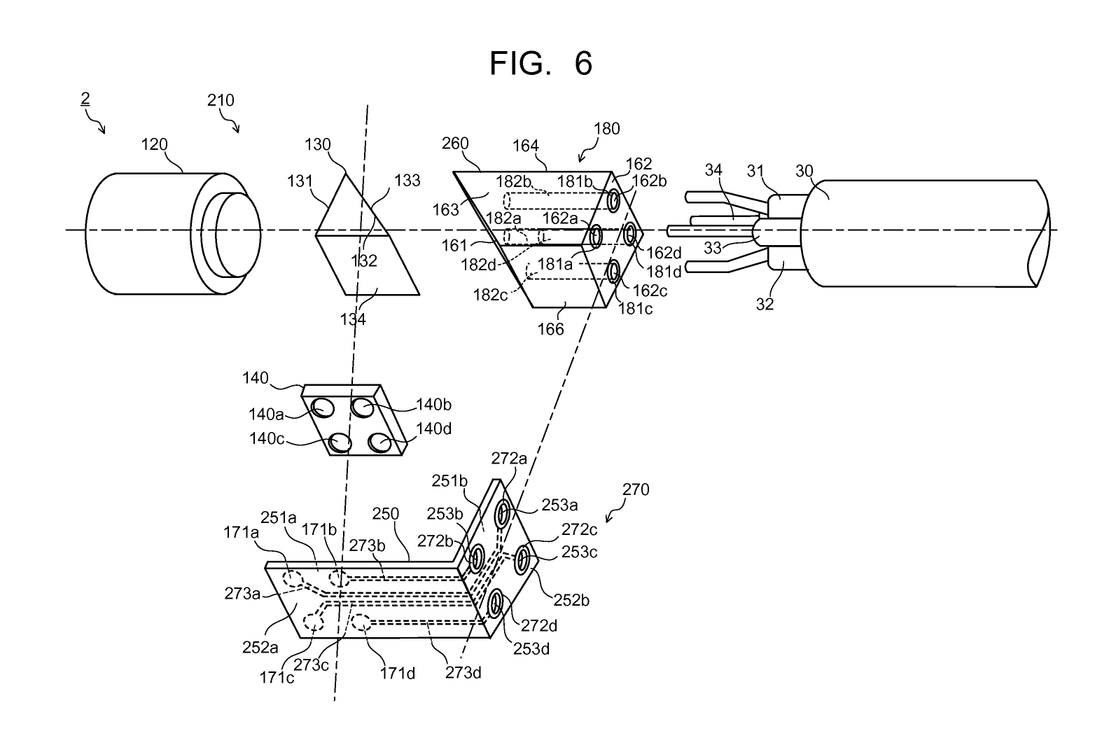

Next, a second embodiment will be described based on FIG. 6. FIG. 6 is an exploded perspective view of a camera head unit 210 and a cable 30 according to the second embodiment. Note that in FIG. 6, the same components as the components in the first embodiment illustrated in FIG. 1 to FIG. 5 are given the same reference signs, and detailed descriptions thereof are omitted.

As illustrated in FIG. 6, an imaging apparatus 2 of the second embodiment has a camera head unit 210. The camera head unit 210 has an FPC 250 and a base 260 instead of the FPC 150 and the base 160 which the camera head unit 110 of the first embodiment has.

The FPC 250 has a substantially L shape. The FPC 250 has a front surface 251a, a front surface 251b, a rear surface 252a, a rear surface 252b, through holes 253a to 253d, and an electrical wiring 270.

The front surface 251a corresponds to the front surface 151 of the FPC 150. The front surface 251b is a surface connected to the front surface 251a. The front surface 251b is disposed to be substantially perpendicular to the front surface 251a. The rear surface 252a corresponds to a rear surface 152 of the FPC 150. The rear surface 252b is a surface connected to the rear surface 252a. The rear surface 252b is disposed to be substantially perpendicular to the rear surface 252a.

In the through holes 253a to 253d (second insertion holes), conducting wire parts of cables 31 to 34 are inserted. The through holes 253a to 253d penetrate through the front surfaces 251b and 252b. The electrical wiring 270 has land parts 171a to 171d, land parts 272a to 272d, and connecting wire parts 273a to 273d.

The land parts 272a to 272d (fourth connecting part) are disposed on the rear surface 252b. A portion of the land part 272a is disposed on a wall surface of the through hole 253a. The portion of the land part 272a disposed on the wall surface of the through hole 253a is electrically connected to the connecting wire part 273a. Another portion of the land part 272a is disposed in an edge portion of the through hole 253a so as to surround the through hole 253a.

Similarly, respective portions of the land parts 272b to 272d are disposed on wall surfaces of the through holes 253b to 253d, respectively. The respective portions of the land parts 272b to 272d are electrically connected to the connecting wire parts 273b to 273d. Respective other portions of the land parts 272b to 272d are disposed in edge portions of the through holes 253b to 253d, respectively, so as to surround the through holes 253b to 253d.

The connecting wire part 273a connects the land part 171a and the land part 272a. Similarly, the connecting wire parts 273b to 273d connect the land parts 171b to 171d and the land parts 272b to 272d, respectively.

The base 260 has a shape and functions corresponding to those of the base 160. A difference between the base 260 and the base 160 is that the base 260 does not have the land parts 183a to 183d and the connecting wire parts 184a to 184d in the electrical wiring 180.

The land part 181a of the base 260 is electrically connected to the land part 272b of the FPC 250. Similarly, the land part 181b is electrically connected to the land part 272a. Similarly, the land part 181c is electrically connected to the land part 272d. Similarly, the land part 181d is electrically connected to the land part 272c.

In the imaging apparatus 2 of the second embodiment having the above structure, the front surface 251b and the rear surface 252b of the FPC 250 intervene between the base 260 and the cable 30. The cables 31 to 34 are inserted in the insertion holes 162a to 162d via the through holes 253a to 253d. By this, electrical and mechanical adhesiveness of the FPC 250 and the base 260 can be enhanced. Further, soldering of the FPC 250, the base 260, and the cables 31 to 34 can be performed in one step, and thus the imaging apparatus 2 can be produced effectively.

### Third Embodiment

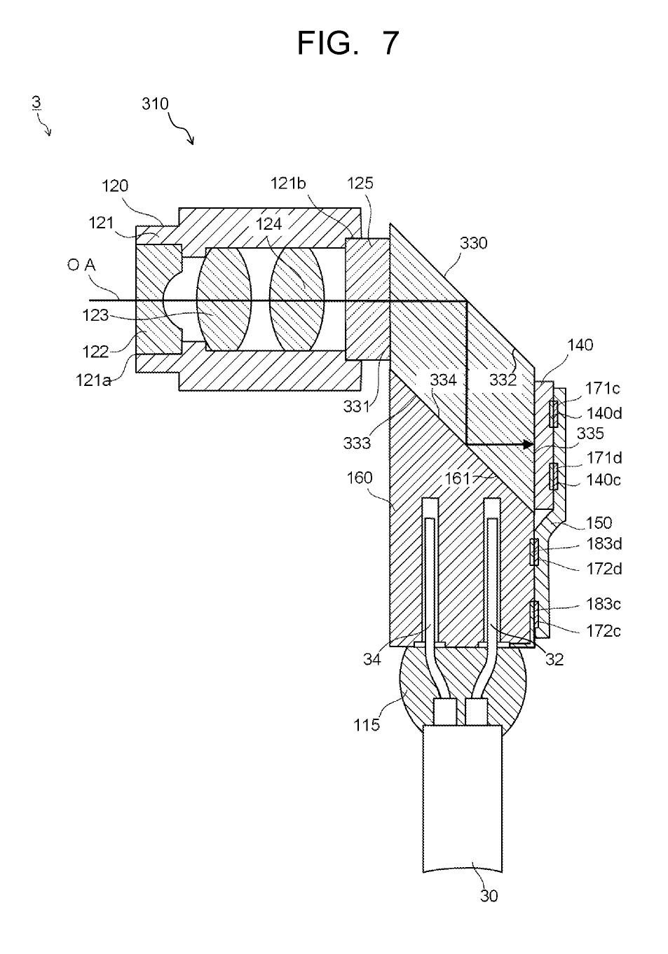

Next, a third embodiment will be described using FIG. 7. FIG. 7 is a view illustrating part of a camera head unit 310 according to the third embodiment by a cross section. Note that in FIG. 7, the same components as the components in the first embodiment illustrated in FIG. 1 to FIG. 5 are given the same reference signs, and detailed descriptions thereof are omitted.

As illustrated in FIG. 7, an imaging apparatus 3 of the third embodiment has a camera head unit 310. The camera head unit 310 has a prism 330 instead of the right-angle prism 130 which the camera head unit 110 of the first embodiment has.

The prism 330 is formed to have a cross section being a substantially parallelogram shape. The prism 330 has an incident surface 331, a reflection surface 332, a rear surface 333, a second reflection surface 334, and an emission surface 335. The incident surface 331 corresponds to the incident surface 131 of the right-angle prism 130.

The rear surface 333 is a rear-side surface of the second reflection surface 334. The rear surface 333 has an inclination corresponding to the inclined surface 161 of the base 160. The rear surface 333 is bonded to the inclined surface 161 with adhesive made of resin for example. The emission surface 335 corresponds to the emission surface 134 of the right-angle prism 130. The reflection surface 332 (first inclined surface) and the second reflection surface 334 (second reflection surface) function as a light refraction part which refracts incident light. The reflection surface 332 and the second reflection surface 334 have a function similar to that of the reflection surface 132. That is, the reflection surface 332 bends the optical axis OA to make it substantially at right angles. The second reflection surface 334 further bends the optical axis OA which is bent by the reflection surface 332 to make it substantially at right angles.

Thus, the prism 330 bends the optical axis OA twice in total by the reflection surface 332 and the second reflection surface 334, so as to guide the light passing through the lens unit 120 to the image sensor 140.

In the imaging apparatus 3 of the third embodiment, by bonding the prism 330 and the base 160, the prism 330, the base 160, and the cable 30 can be disposed in a straight line. Then, in the imaging apparatus 3, by having the prism 330, the lens unit 120 can be attached in a direction orthogonal to a direction in which the prism 330, the base 160, and the cable 30 are aligned. As a result, in the imaging apparatus 3, the entire camera head unit 310 becomes a substantially L shape.

Thus, while reducing the size of the camera head unit 310, an image in the direction orthogonal to the direction in which the prism 330, the base 160, and the cable 30 are aligned can be obtained by the image sensor 140. For example, an image of a portion bent in an L shape inside a human body can be obtained easily.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the first embodiment, the electrical wiring 180 is formed on the surfaces of the base 160, but it can also be formed inside the base 160. For example, a TAB (Tape Automated Bonding) or a printed circuit board may be used instead of the FPC 150.

What is claimed is:

1. A camera head, comprising:
a lens configured to pass light;
a prism having
an incident surface configured to receive the light passed through the lens,
a light refraction part having an inclined surface configured to change a traveling direction of the light passed through the incident surface, and
an emission surface configured to emit the light changed in traveling direction by the inclined surface;
an imaging element to receive the light emitted from the emission surface and to output an electrical signal corresponding to the received light;
a signal cable;
a support member comprising
a first surface attached to a rear-side surface of the inclined surface, the first surface having an inclination corresponding to the inclined surface,
an insertion hole receiving the signal cable inserted therein, and
a second surface having a connecting part electrically connected to the signal cable inserted in the insertion hole; and
a wiring substrate having a first area and a second area, the imaging element being mounted on the first area, the second area being electrically connected to the connecting part.

2. The camera head of claim 1, wherein the lens, the prism, the support member, and the signal cable are disposed in order in a straight line.

3. The camera head of claim 1, wherein the support member further has a third surface having a second connecting part electrically connected to the wiring substrate and an electrical wiring part wiring from the connecting part to the second connecting part.

4. The camera head of claim 3, wherein the wiring substrate further has a third connecting part disposed in the second area and electrically connected to the second connecting part.

5. The camera head of claim 1, wherein the wiring substrate further has a second insertion hole disposed in the second area and a fourth connecting part disposed around the second insertion hole, the signal cable being inserted in the second insertion hole, the fourth connecting part being electrically connected to the connecting part.

6. The camera head of claim 1, wherein the light refraction part has
a first inclined surface configured to change a traveling direction of the light passed through the incident surface and
a second inclined surface configured to further change the traveling direction of the light changed in traveling direction by the first inclined surface, and
the first surface of the support member is attached to a rear-side surface of the second inclined surface.

7. The camera head of claim 6, wherein the prism, the support member, and the signal cable are disposed in order in a straight line, and an optical axis of the light passing through the lens is orthogonal to a direction in which the prism, the support member, and the signal cable are aligned.

8. A connecting method of a camera head, the method comprising:
preparing a prism having
an incident surface to receive light,
a light refraction part having an inclined surface, the inclined surface changing a traveling direction of the light passed through the incident surface, and
an emission surface to emit the light changed in traveling direction by the inclined surface;
preparing a wiring substrate having a first area prepared for mounting an imaging element thereon and a second area different from the first area, the imaging element outputting an electrical signal corresponding to the light emitted from the emission surface;
attaching the imaging element to the emission surface;
attaching a lens configured to pass light to the incident surface;
preparing a support member comprising
a first surface attached to a rear-side surface of the inclined surface, the first surface having an inclination corresponding to the inclined surface,
an insertion hole receiving the signal cable inserted therein, and
a second surface having a connecting part electrically connected to the signal cable inserted in the insertion hole;
attaching the first surface to the rear-side surface of the inclined surface;
connecting the connecting part and the wiring substrate; and
attaching the signal cable into the insertion hole.

9. The connecting method of claim 8, wherein the lens and the support member are disposed coaxially with each other via the prism.

10. The connecting method of claim 8, wherein the support member further has a third surface having a second connecting part electrically connected to the wiring substrate and an electrical wiring part wiring from the connecting part to the second connecting part.

11. The connecting method of claim 10, wherein the wiring substrate further has a third connecting part disposed in the second area and electrically connected to the second connecting part.

12. The connecting method of claim 8, wherein the wiring substrate further has a second insertion hole disposed in the second area and a fourth connecting part disposed around the second insertion hole, the signal cable being inserted in the second insertion hole, the fourth connecting part being electrically connected to the connecting part.

13. The connecting method of the camera head of claim 8, wherein the light refraction part has
a first inclined surface configured to change a traveling direction of the light passed through the incident surface and a second inclined surface configured to further change the traveling direction of the light changed in traveling direction by the first inclined surface, and
the first surface of the support member is attached to a rear-side surface of the second inclined surface.

14. An endoscope apparatus, comprising:
a lens configured to pass light;
a prism having
an incident surface configured to receive the light passed through the lens,
a light refraction part having an inclined surface configured to change a traveling direction of the light passed through the incident surface, and
an emission surface configured to emit the light changed in traveling direction by the inclined surface;
an imaging element to receive the light emitted from the emission surface and to output an electrical signal corresponding to the received light;
a signal cable;
a support member comprising
a first surface attached to a rear-side surface of the inclined surface, the first surface having an inclination corresponding to the inclined surface,
an insertion hole receiving the signal cable inserted therein, and
a second surface having a connecting part electrically connected to the signal cable inserted in the insertion hole; and
a wiring substrate having a first area and a second area, the imaging element being mounted on the first area, the second area being electrically connected to the connecting part.

15. The endoscope apparatus of claim 14, wherein the lens, the prism, the support member, and the signal cable are disposed in order in a straight line.

16. The endoscope apparatus of claim 14, wherein the support member further has a third surface having a second connecting part electrically connected to the wiring substrate and an electrical wiring part wiring from the connecting part to the second connecting part.

17. The endoscope apparatus of claim 16, wherein the wiring substrate further has a third connecting part disposed in the second area and electrically connected to the second connecting part.

18. The endoscope apparatus of claim 14, wherein the wiring substrate further has a second insertion hole disposed in the second area and a fourth connecting part disposed around the second insertion hole, the signal cable being inserted in the second insertion hole, the fourth connecting part being electrically connected to the connecting part.

19. The endoscope apparatus of claim 14, wherein the light refraction part has
a first inclined surface configured to change a traveling direction of the light passed through the incident surface and
a second inclined surface configured to further change the traveling direction of the light changed in traveling direction by the first inclined surface, and
the first surface of the support member is attached to a rear-side surface of the second inclined surface.
